(19) United States
(12) Patent Application Publication
(10) Pub. No.: US 2006/0226127 A1
(43) Pub. Date: Oct. 12, 2006

(54) Positioning device for positioning transverse wires for a mesh-welding machine

(75) Inventor: Hansjorg Muller, Ebentswil (CH)

Correspondence Address: BIRCH STEWART KOLASCH & BIRCH, PO BOX 747, FALLS CHURCH, VA, 22040-0747, US

(73) Assignee: H.A. SCHLATTER AG, Schlieren (CH)

(21) Appl. No.: 11/384,560

(22) Filed: Mar. 21, 2006

(30) Foreign Application Priority Data
Mar. 21, 2005 (EP) 05405255.0

(51) Int. Cl. B23K 11/00

(52) U.S. Cl. 219/56

(57) ABSTRACT

A positioning device for positioning transverse wires for a mesh-welding machine has a guide (101) for receiving one of the transverse wires and two slides (120, 140), which can move freely, for making contact with the transverse wire received in the guide (101) at two opposite end sides. The slides (120, 140) are designed in such a manner that the transverse wire, which has been put down in any arbitrary receiving position in the guide (101), can be moved along the guide (101) by the slide (120, 140) into any desired, predetermined release position. The two freely moveable slides (120, 140), between which the transverse wire is held, allow accurate and rapid displacement of the transverse wire in both transverse directions. Moreover, the presence of two individually controllable slides (120, 140) allows a high degree of flexibility in transverse wire positioning, by virtue of the fact that transverse wires of very differing lengths can be put in any arbitrary receiving position in the guide and moved into any desired release position. In this way, it is possible to produce even complex meshes.

### FIELD OF THE INVENTION

The invention relates to a positioning device for positioning transverse wires for a mesh-welding machine. The invention also relates to a method for inserting transverse wires into a mesh-welding machine, to a control apparatus for a mesh-welding machine and to a computer program product for a control apparatus of this type.

### PRIOR ART

Mesh-welding machines, to which transverse wires are fed in succession in order to be welded to a row of spaced-apart longitudinal wires, are generally known. The transverse wires often need to be positioned in a predetermined transverse position (relative to the longitudinal wires) prior to the welding operation. Accurate positioning makes it possible, for example, to ensure that all the transverse wires have a predetermined lateral projection beyond the longitudinal wires or end flush with the longitudinal wires. This means that there is no need to cut off transverse wire ends with an excessively large projecting length following the welding operation. Transverse positioning is also required if the transverse wires are delivered in different transverse positions or for the production of complex meshes if transverse wires of different lengths and/or transverse wires at different transverse positions are to be welded to the longitudinal wires.

There are various known apparatuses for positioning transverse wires:

EP 0 622 136 A1 (Michael R. Koch) discloses an apparatus for producing reinforcing meshes, which is supposed to enable the transverse wire ends to be automatically and reliably aligned with one another on one side. For this purpose, a stop element is arranged displaceably on a transverse guide, it being possible to effect the displacement for example by means of a spindle. The stop element is initially retracted and, after the transverse wire has been introduced, is displaced together with the transverse wire as far as a defined, adjustable position. In this final position, the transverse wire is welded to the longitudinal wires.

This apparatus can only align projecting ends of successive transverse wires with one another on one side; further positioning operations are not provided. Therefore, the apparatus disclosed is inflexible. Moreover, it can only achieve a low positioning accuracy.

DE-A 2 133 845 (EVG) shows a mesh-welding machine to which transverse wires of different lengths can be fed. For this purpose, driven transport rollers are provided for advancing the transverse wires, the drive being connected to an actual value sensor for the transverse wire advance length, so that the transport rollers can be stopped when the desired transverse wire welding position is reached.

The positional accuracy that can be achieved with this apparatus and the speed of positioning which is possible are limited. Moreover, the apparatus is of complex construction.

EP 0 214 449 A1 (EVG) describes a multi-spot resistance welding machine which can also be used to produce meshes which have transverse wires of different lengths and which are arranged in any desired transverse position. For this purpose, there are two feed devices for supplying transverse wires, at least one of which is displaceable in a guide transversely with respect to the advancing movement of the longitudinal wires.

This apparatus allows the positioning of transverse wires of different lengths. However, if successive transverse wires of the same length are to be welded in different transverse positions, a displacement of the entire displaceable feed device is required, thereby greatly restricting the speed which can be achieved. This apparatus is also of complex construction and, moreover, is unsuitable for a relatively large number of different transverse wire lengths.

DE 30 25 320 C2 (Masamitsu Ishihara) shows an apparatus for supplying rods, having an advancing member which bears against one end of the rods and can be moved along the conveying direction. At the other end, the rods bear against a stop, which can likewise be moved in the conveying direction, is held in a starting position by a restoring force and is coupled to a measuring apparatus for measuring the position of the wire. The stop is coupled to a piston rod which slides in a cylinder in a pneumatic piston/cylinder unit. The supply of compressed air to the unit is controlled in such a manner that a constant prestress is applied to the stop.

This apparatus is of complex structure. Moreover, it is inflexible, since the rods can only be moved in one direction, and refitting is required in the event of a change in the mesh geometry. Complex meshes cannot be produced using this apparatus.

### SUMMARY OF THE INVENTION

It is an object of the invention to provide a positioning device belonging to the technical field described in the introduction for positioning transverse wires for a mesh-welding machine, which positioning device is of simple construction and allows fast and accurate positioning of the transverse wire and a high degree of flexibility in terms of the production of meshes.

The solution to the object is defined by the features of claim 1. According to the invention, the positioning device has a guide for receiving one of the transverse wires and two freely moveable slides for making contact with the transverse wire received in the guide at two opposite end sides. The slides are designed in such a manner that the transverse wire, which has been put down in any arbitrary receiving position in the guide, can be moved along the guide by the slides into any desired, predetermined release position.

The two freely moveable slides, between which the transverse wire is held, allow fast and accurate displacement of the transverse wire in both transverse directions, unlike known solutions with one fixed (or resiliently mounted) stop and only one freely moveable element arranged opposite the stop. The provision of two individually controllable slides allows a high degree of flexibility in transverse-wire positioning, by virtue of the fact that transverse wires with a very wide range of lengths can be received in any arbitrary receiving position in the guide and moved into any desired release position. Since the slides make contact with the end sides of the transverse wire, moreover, the positioning is independent of the cross section of the transverse wire that is to be positioned. This provides the device with a high level of flexibility and allows the production of complex meshes. Resetting of the device is not required either in the event of a change in the receiving position or in the event of a change in the transverse wire lengths and/or the transverse wire diameters.

To ensure a high level of flexibility, the slides are preferably in each case able to move freely at least over substantially half the length of the guide. A maximum degree of flexibility is achieved if the slides can move freely along the entire length of the guide.

Furthermore, a device of this type can easily be reset for two-track operation. If two meshes with widths which cumulatively amount to at most the maximum mesh width of the machine are to be produced in an existing mesh-welding machine, it is possible for two meshes to be produced next to one another in parallel. The device according to the invention can easily be modified for this purpose by virtue of a stationary, two-sided stop being mounted at the appropriate position of the guide between the meshes that are to be produced. The transverse rods of the two meshes can then in each case be moved onto the fixed stop by the two lateral slides. Although some further benefits of the invention may be lost after this refit, with in particular the flexibility of the transverse positioning being restricted, standard two-track operation on a mesh-welding machine remains possible without restriction.

In the context of the present description, the term “transverse wire” is intended to encompass rod-like, i.e. substantially straight elements with a substantially constant cross section which are welded in the mesh-welding machine to a plurality of longitudinal wires, irrespective of their cross section (i.e. the term also encompasses in particular transverse wires of relatively large cross section, which are also referred to as transverse rods).

The apparatus is advantageously controlled in such a manner, prior to the introduction of the transverse wire into the guide, both slides are moved into lateral starting positions. The distance between the slides in these starting positions is in this case a length of the transverse wire to be introduced plus a maximum expected position tolerance of the transverse wire. The slides are therefore positioned in such a manner that the transverse wire is reliably introduced into the guide between the two slides. At the same time, however, the distance which it is necessary to move the slides is minimized, which reduces firstly the time required and secondly the mechanical loading on the slides and their actuating mechanism. A maximum expected transverse wire length, i.e. the predetermined transverse wire length plus a maximum expected length tolerance, is used to determine the starting positions.

For certain transverse wire feeds, the device according to the invention can be operated in such a way that prior to the introduction of the transverse wire, the slides are moved onto the opposite lateral ends of the guide, so that each transverse wire, which is introduced into the guide at any receiving position, can be moved to the predetermined release position.

The device is controlled by a control apparatus which, for example, is integrated in the machine control of the mesh-welding machine. The control apparatus is controlled in particular by a computer program product, which executes the method according to the invention described here for inserting transverse wires.

It is advantageous for the slides in each case to be coupled to a servo axle. This allows simple, fast and extremely accurate control of the positioning device. Servo axles can easily be actuated by computer controls.

It is preferable for the coupling of the slides to the servo axles to be effected using endless coupling means, in particular toothed belts. These are lightweight, inexpensive and allow highly dynamic coverage of long displacement distances. Alternatively, it is possible to provide other coupling means, for example spindles.

In another preferred embodiment, the servo axles are formed by a linear drive or by a plurality of linear drives. These allow a high level of positioning accuracy and a high level of dynamics. Moreover, the number of moving parts and therefore the susceptibility to faults are minimized.

Advantageously, one of the slides has a resiliently mounted stop for compensating for length tolerances in the transverse wires. As mentioned above, during the initial positioning of the slides, the length tolerances of the transverse wires can be taken into account by increasing the initial distance between the slides by the expected maximum tolerance. Then, the slides are moved inwards, i.e. towards one another, in order to make contact with the transverse wire and then move it into the predetermined position. If the transverse wire, on account of length tolerances, has a greater length than the predetermined length, in the case of fixed stops at least one of the slides can no longer be displaced any further before it reaches its predetermined target position. The resiliently mounted stop can compensate for this residual distance, so that both slides can reach the predetermined final position. Therefore, the slides do not strike the transverse wire firmly, but rather only the weak restoring spring forces transmitted to the drives, which consequently are not excessively stressed.

The final positions of the slides are preferably predetermined in such a way that they correspond to the predetermined transverse wire length minus the maximum expected length tolerance. The spring displacement of the resiliently mounted stop then corresponds to (at least) double the maximum length tolerance. Therefore, during the positioning of a transverse wire of the correct length, precisely half the spring displacement of the stop is consumed. Both slightly longer and slightly shorter transverse wires can be accurately positioned without it being necessary to adapt the control.

In single-track operation, one of the slides may have the resilient stop, or both slides may have a resilient stop, depending on whether, in the event of wires which have a length which is above or below the intended length, the centre of the wire or a defined end of the wire is to be placed in a predetermined position. In the case of two-track operation (cf. above), it is preferably for both slides to be equipped with a resilient stop. Therefore, it is expedient for the slides to be of exchangeable design, so that during resetting to two-track operation, the slide without a resilient stop can be exchanged.

Alternatively, the stops of the slides are fixed and the length tolerances are taken into account in some other way. By way of example, the slide drive itself or coupling means between the drive and the slides may be able to compensate for the tolerance. It is also possible to detect the increase in force on making contact with the transverse wire and for the slides to be stopped accordingly, or for the effective length of the transverse wire to be determined by sensors before the slide movement is carried out and taken into account during the movement of the slides.

It is preferable for one of the slides to have a release mechanism, which is designed in such a manner that in the event of a predetermined release force on the slide, an element which makes contact with the transverse wire is released, i.e. mechanically separated, for example disengaged, from the slide. This prevents the introduction of excessively long transverse wires from being able to damage the machine, in particular the positioning device. The release mechanism is advantageously combined with a resiliently mounted stop (as described above). The resiliently mounted stop can be regularly knocked back, whereas the releasing of the release mechanism can only occur in very unusual circumstances, namely when smooth further operation of the welding machine would in any case be rendered impossible by the length of the transverse wire which has been introduced.

Furthermore, as an alternative it is possible to provide a release mechanism which is arranged at a different location of the positioning device. The increase in force on making contact with the transverse wire can be detected and the procedure can be stopped appropriately, or the effective length of the transverse wire is determined by sensors prior to the execution of the slide movement, so that the procedure can be interrupted.

The guide is advantageously designed as a trough running in the transverse direction. The transverse wire is held securely in this trough and can easily be displaced in the transverse direction, for example by slides with stops which are matched to the trough. The shape of the trough defines a provision position which—irrespective of the transverse wire diameter—is provided by the region of lowest potential energy. As a result, certain tolerances are permitted during introduction of the transverse wire, by virtue of the fact that the latter automatically moves into this lowest region of the trough on account of the force of gravity. The trough does not have to be continuous in form, but rather may, for example, be formed by a plurality of trough-like supporting elements.

Alternatively, the guide is formed as a planar, horizontal or inclined surface.

An apparatus for inserting transverse wires into a mesh-welding machine preferably comprises a positioning device as described above, which is arranged at a distance from a welding position of the mesh-welding machine.

In some of the known mesh-welding machines, the final transverse positioning of the transverse wires only takes place at the welding position. Therefore, the welding operation can only take place once the transverse positioning has taken place. Therefore, the duration of a transverse-wire welding cycle is determined by the welding time required plus the time required for the transverse positioning. As a result, the throughput is reduced in conventional mesh-welding machines. Furthermore, the known solutions require a complex and unwieldy structure, since both the welding tools and the means for the transverse positioning of the transverse wire have to be accommodated within a small space.

The introduction of the transverse wire into the positioning device, which is at a distance from the welding position, and the subsequent transverse positioning of the transverse wire in the guide can take place in parallel with the welding operation of a preceding transverse wire and do not lead to any lengthening of the welding cycle. Only after transverse positioning has been completed is the transverse wire transported to the welding position. The welding operation can be carried out immediately after the transverse wire has been placed in the welding position, i.e. after contact with the longitudinal wires that are to be welded to the transverse wire. This increases the possible throughput of the welding machine.

At the same time, it is possible—without reducing the capacity—to move the transverse wire over a greater transverse distance without the dynamics of the positioning device having to be increased. In principle, therefore, the transverse wire can first of all be put down at any arbitrary position on the guide, after which it is moved into the predetermined position. Therefore, the demands imposed on the prior feed for the transverse wires are not particularly high. They can be of correspondingly simple and inexpensive construction.

The apparatus for inserting transverse wires advantageously also comprises a transport apparatus for transporting the positioned transverse wire from the guide into the welding position, which is designed in such a manner that the transverse position of the transverse wire is maintained during transport. Therefore, accurate positioning of the transverse wire in the guide is also retained during transport. The combination of the positioning device according to the invention with a transport apparatus of this type therefore allows flexible and extremely accurate positioning of the transverse wires without adversely affecting the throughput of the mesh-welding machine.

The transport device advantageously comprises a moveable gripper for taking hold of, transporting and putting down the transverse wire. This gripper is preferably moveable in a vertical plane which is parallel to the longitudinal direction of the mesh-welding machine, and during the transport operation is not moved out of this plane. Moreover, the gripping mechanism of the gripper is designed in such a way that the transverse wire cannot be displaced in the transverse direction with respect to the gripper for as long as it is held by the gripper. This ensures that the transverse position of the transverse wire is retained during the taking-hold, transporting and putting-down of the transverse wire. There is preferably a further device for inserting the transverse wires. Therefore, the next transverse wire can be fed to the guide as soon as the gripper has taken hold of a positioned transverse wire located in the guide and removed it from the guide. It is preferable to provide a plurality of grippers which can take hold of the transverse wire along its axis.

Alternatively, the transverse wire is transported out of the guide, for example along an inclined plane to the welding position, the positioning device comprising lateral boundaries for the inclined plane, which ensure that as the transverse wire is sliding down it cannot move in the transverse direction. As a further option, the transport device may, for example, comprise a conveyor belt.

If the demands imposed on the accuracy of the transverse wire position are low, the transverse wire which has been positioned in the guide can be moved into the welding position in other ways. By way of example, it can drop freely out of the guide into the welding line along a plane running obliquely downwards.

To take hold of the transverse wire, the gripper advantageously engages in a space between two spaced-apart sections of the (for example trough-like) guide. In this way, the gripper can enclose the transverse wire unimpeded by the guide, can thereby securely take hold of the transverse wire and remove it from the guide. Moreover, lower demands are imposed on the dimensions of the gripper than if it has to move into a continuous guide in order to take hold of the transverse wire.

It is customary for a plurality of grippers, which grasp the transverse wire at a plurality of locations along its length, to be used to take hold of a transverse wire. The number and therefore also the arrangement of the grippers required depend on the length, cross section and material of the transverse wire. To enable the apparatus according to the invention for inserting transverse wires to be quickly adapted to the material to be processed, the guide is advantageously formed by a plurality of optionally removable sections. At the locations at which a gripper is to engage around the transverse wire, one of the sections is omitted or removed so as to form a space, the dimensions of which permit the engagement of the gripper. Since in operation large spaces are present only where they are actually required, the result at the same time is optimum receiving of the transverse wire in the guide.

The optionally removable sections of the guide can preferably be secured to a support using a clip connection. This allows a simple design with a minimum number of securing means and also allows simple and time-saving fitting and removal of the sections. The clip connection can be designed in such a way that the section can be secured to or removed form the support without the aid of a tool.

Alternatively, the individual sections are, for example, bolted to the support, or the guide comprises a plurality of fixedly arranged segments, between each of which a sufficiently large space for the engagement of the gripper is left clear.

Different transverse positions may be predetermined for successive transverse wires, depending on the shape of the mesh to be produced and depending on the length of the transverse wires to be introduced. This allows the production of meshes which comprise transverse wires of different length and/or with different transverse positioning. In such a situation, the starting position of the slides is determined, for example, by beginning from a predetermined position of the centre of the transverse wire, with the slides on both sides in each case being at a distance of half the transverse wire length (with length tolerance, cf. above) plus half the maximum expected position tolerance from the centre position.

Alternatively, the apparatus is controlled in such a way that the transverse position of the wires is a predetermined constant during a production sequence.

A mesh-welding machine having a positioning device according to the invention may comprise two or more devices for providing transverse wires mounted ahead of the apparatus for inserting the transverse wires, with the transverse positions of these devices being different. The flexible positioning device allows the transverse wires, which have been introduced into the guide of the positioning device by the devices, to be moved into any desired, predetermined release positions irrespective of their receiving position. This allows numerous configurations of a plurality of devices; they can be arranged not only behind one another but also, for example, next to one another in the transverse direction, with the result that the space taken up by the transverse wire feeds in the longitudinal direction of the machine can be reduced.

In general terms, it should be noted that the positioning device according to the invention reduces the demands imposed on the transverse positioning of the transverse wires and therefore on the position of the devices for providing transverse wires to a considerable extent compared to known solutions, so that in particular accurate adjustment of the elements of the devices for providing the transverse wires which determine the transverse position can be dispensed with.

A mesh-welding machine having a positioning device according to the invention may furthermore comprise a system for producing the transverse wires from a wire stock. This is mounted ahead of the apparatus for inserting the transverse wires. By means of this system, the transverse wires are pulled from a wire stock, e.g. a wire reel, cut to a predetermined length and finally introduced into the guide of the positioning device, in which they are then moved to a predetermined transverse position irrespective of their transverse position during introduction. This allows a simple and flexible structure of the mesh-welding machine. The system for producing the transverse wires is advantageously able to produce a sequence of transverse wires of any desired lengths. By way of example, round meshes (e.g. grill meshes), in which the length from transverse wire to transverse wire initially increases and then decreases again, can be produced easily and without loss of material.

The system for producing the transverse wires is advantageously arranged in such a manner that transverse wires which have been cut to size are placed directly from the system into the guide for positioning. This obviates the need for an additional device for inserting the transverse wires into the guide, thereby optimizing the method sequence. The positioning device can be controlled in such a way that irrespective of their length the transverse wires are always “picked up” at the same location and are then moved into the predetermined transverse position. A cutting apparatus (shearing mechanism) of the system for producing the transverse wires can therefore remain arranged in a stationary position even in the event of different predetermined release positions for successive transverse wires. Since the position of the relatively heavy shearing mechanism therefore need not be changed during the procedure even in the event of transverse wires of different lengths and/or that are to be arranged in different positions, a higher level of dynamics is possible in the procedure without any reduction in flexibility. By way of example, the Syrocut wire cutting and straightening system produced by H. A. Schlatter AG, Schlieren, Switzerland is suitable for use as the system for producing transverse wires for use with the mesh-welding machine according to the invention.

The following detailed description and the combination of patent claims give further advantageous embodiments and combinations of features of the invention.

### BRIEF DESCRIPTION OF THE DRAWINGS

In the drawings used to explain the exemplary embodiment:

FIG. 1 shows a perspective view of the positioning device according to the invention for positioning transverse wires for a mesh-welding machine;

FIG. 2 shows a vertical cross section through the positioning device parallel to the longitudinal axis of the mesh-welding machine;

FIG. 3 shows a perspective view of a slide of the positioning device with a resiliently mounted stop and a release apparatus;

FIG. 4 shows a vertical cross section through the positioning device and a transport device of an apparatus according to the invention for inserting transverse wires parallel to the longitudinal axis of the mesh-welding machine;

FIGS. 5A-D diagrammatically depict the method sequence involved in positioning a transverse wire;

FIGS. 6A-F diagrammatically depict the method sequence involved in positioning transverse wires of different lengths;

FIGS. 7A-D diagrammatically depict the method sequence involved in positioning transverse wires which have been placed in the guide directly from a system for producing transverse wires from a wire stock;

FIG. 8 shows a perspective view of a second embodiment of a positioning device according to the invention having a guide with a plurality of optionally removable sections; and

FIG. 9 shows a vertical cross section through the second embodiment of the positioning device parallel to the longitudinal axis of the mesh-welding machine.

In principle, identical parts are provided with identical reference designations throughout the figures.

### WAYS OF CARRYING OUT THE INVENTION

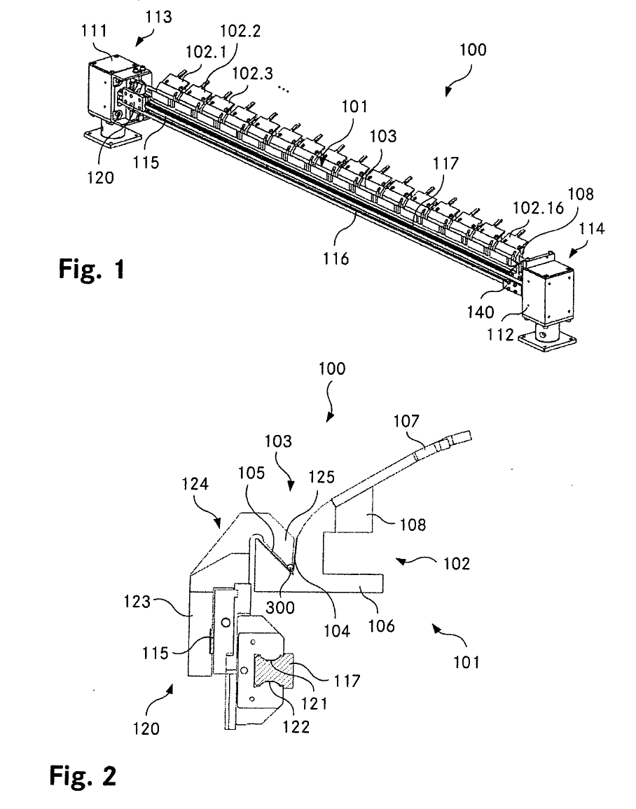

FIG. 1 shows a perspective view of the positioning device according to the invention for positioning transverse wires for a mesh-welding machine. FIG. 2 shows a vertical cross section through the positioning device 100 with the guide 101 parallel to the longitudinal axis of the mesh-welding machine. The longest extent of the guide 101 runs in the transverse direction (with respect to the mesh-welding machine) The guide 101 is formed by a plurality of trough elements 102.1 . . . 102.16, which together form a trough 103 which extends in the transverse direction and in which a transverse wire can be received. The trough elements 102.1 . . . 102.16 comprise a trough part 106, in which the trough 103 is formed, and a guide part 107, which is oriented obliquely downwards towards the trough 103 and along which transverse rods delivered from an upstream feed unit can slide in the direction of the trough 103. The trough parts 106 and the guide parts 107 of the trough elements 102.1 . . . 102.16 are bolted to a support 108 running in the transverse direction. As can be seen from FIG. 2, the trough has a v-shaped cross section, i.e. is formed by two walls 104, 105 running towards one another, of which the rear wall 104 is approximately vertical and the front wall 105 is inclined at an angle of approx. 40° with respect to the vertical.

Housings 111, 112 of the positioning device 100 are arranged at both lateral ends of the guide 101. Each of the housings 111, 112 comprises a servomotor 113, 114. The latter are coupled, via drive wheels that can rotate about vertical axes, to in each case an encircling toothed belt 115, 116. The pulleys for the toothed belts 115, 116 are arranged in the housings 111, 112 lying opposite the servomotor 113, 114 such that they can rotate about a vertical axis.

A rail 117 is secured between the housings 111, 112, parallel to the toothed belts 115, 116. This rail has a H-shaped profile with recesses on the top side and underside. Two slides 120, 140 are displaceable in the transverse direction on the rail 117. For this purpose, the slides 120, 140 (as diagrammatically depicted in FIG. 2 on the basis of the slide 120) have two opposite rollers 121, 122, which run in the recesses in the rail 117. The first slide 120 is secured to the first toothed belt 115, and the second slide 140 is secured to the second toothed belt 116.

The slides 120, 140 are arranged obliquely beneath and in front of the trough 103, i.e. between the guide 101 and the welding position. Starting from the main part 123 of the slides 120, 140 (illustrated once again with reference to the slide 120), a stop part 124 extends upwards and to the rear. A stop 125, the cross section of which engages suitably in the trough 103 so that it can make contact with the transverse wire 300 located in the lowest region of the trough 103, is formed at the end of the stop part 124.

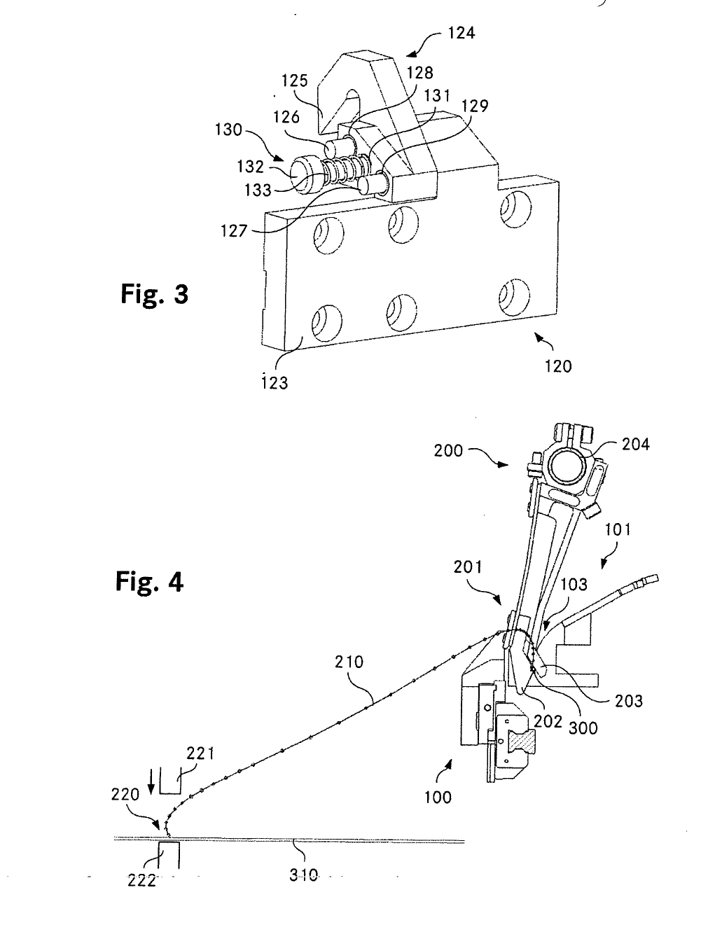

FIG. 3 shows a perspective view of a slide of the positioning device, having a resiliently mounted stop and a release apparatus. As has been mentioned, the slide 120 comprises a main part 123 and a stop part 124 with a stop 125. The stop part 124 is mounted resiliently on the main part 123. For this purpose, the main part 123, on a connection part, has two guide pins 126, 127 which are oriented in the transverse direction when the slide 120 is fitted. The stop part 124 slides on the two guide pins 126, 127. For this purpose, it has sliding guides 128, 129 which are formed in a foot region of the stop part 124. A further pin 130, which is held in a clamping ring secured to the main part 123 and passes through a corresponding opening 131 in the stop part 124, is arranged between the guide pins 126, 127. On the outer side of the stop part 124, at a distance from the latter, the pin 130 has a head 132. A coil spring 133 is held on the pin 130 between the head 132 and the stop part 124.

As soon as a certain force acts on the rear side of the stop 125, the latter is pressed outwards with respect to the main part 125, counter to the force of the coil spring 133, sliding along the guide pins 126, 127 as it does so. This allows different transverse wire lengths to be compensated for. In the event of excessively long transverse wires, the surplus length of which exceeds the spring travel, or in the event of other problems which lead to high forces on the stop 125, the stop part 124 is pressed outwards until the spring has been fully compressed and the stop part 124 presses directly against the head 132 of the pin 130. The clamping ring in the main part 123 is designed in such a way that the pin 130 is released from the main part 123 under a certain force. As soon as this has occurred, the stop part 124 can slide further outwards on the guide pins 126, 127 until it is detached from the pins 126, 127 and therefore from the main part 123. Therefore, in the event of high forces the stop part 124 is disengaged, so that the forces do not act on the main part 123 of the slide 120 and therefore also do not act via the coupling means on the drive for the slide 120.

FIG. 4 shows a vertical cross section through the positioning device 100 and a transport device 200 of an apparatus according to the invention for inserting transverse wires parallel to the longitudinal axis of the mesh-welding machine. The transport device 200 comprises a plurality of grippers 201 with two pincer-like gripping jaws 202, 203, which can move with respect to one another and are designed in such a manner that the transverse wire 30, can be taken hold of between the gripping jaws 202, 203, held during transport and released again at the destination. All the grippers 201 are secured to a tube 204 running in the transverse direction. This tube is held by a plurality of articulated arm mechanisms (not shown) which are arranged in parallel and are actuated synchronously. The gripper 201 illustrated can therefore be moved parallel to the longitudinal direction of the machine in the vertical plane illustrated in FIG. 4. The articulated arm mechanisms will not be dealt with in more detail at this point. There are numerous solutions which, by means of the tube 204, allow the grippers 201 to be transported and if appropriate rotated about a horizontal axis that is transverse with respect to the transporting plane. By way of example, it is possible to use bent-arm robots (with two or more parallel axes of rotation, for example standard SCARA robots) or Cartesian robots. The number of articulated arm mechanisms arranged in the transverse direction along the tube 204 is selected as a function of the width of the mesh-welding machine and therefore as a function of the length of the tube 204. Three mechanisms arranged in parallel are sufficient for typical mesh-welding machines. In the case of narrow machines, two will suffice, and in the case of wide machines four or more mechanisms may be required.

The gripper 201 has a small extent in the transverse direction and can therefore engage between the trough elements 102.1 . . . 102.16 (cf. FIG. 1) and grip the transverse wire which has been inserted into the trough 103 of the guide 101, in the manner illustrated in FIG. 4. To ensure reliable transport, at least two, but preferably, depending on the transverse wire length, up to eight or more synchronously controlled grippers 201 are provided.

After the transverse wire 303 has been taken hold of by the grippers 201, it is transported along a transporting distance 201 to the welding position 220 without any change in the transverse position. At the welding position, it is put down on the longitudinal wires 310. Immediately afterwards, the welding operation can take place by the upper electrode 221 being moved downwards, onto the intersection points between the transverse wire 300 and the longitudinal wires 310, and onto counterelectrodes 222 arranged beneath the welding position 220, after which a welding current is passed through the intersection points until a desired weld has been produced. As the method continues, the transverse wire 300 is transported onwards together with the longitudinal wires.

As soon as the transverse wire 300 has been placed in the welding position 220, the gripper 201 returns to the position shown in FIG. 4, in order to take hold of the next transverse wire, which has in the meantime been positioned in the transverse direction in the trough 103.

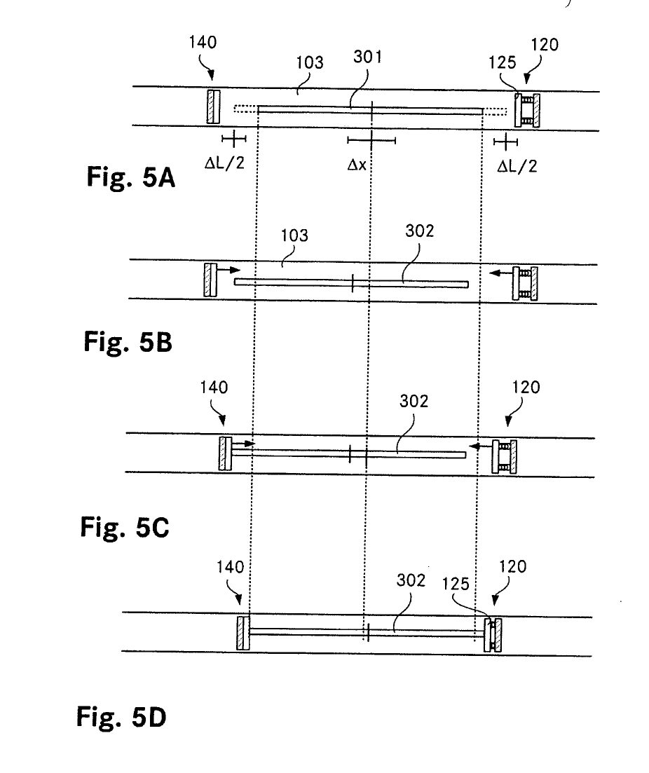

FIGS. 5A-5D diagrammatically depict the method sequence involved in positioning a transverse wire. FIG. 5A shows the predetermined positioning of a transverse wire 301 of correct length and the starting position of the slides 120, 140. The feed apparatus is designed in such a manner that the transverse wire 301 is placed with a maximum position error Δx next to the predetermined position in the trough 103. The possible wire positions are indicated by dashed lines. The maximum expected deviation in the length of the transverse wire is ΔL. It should be noted that the expected error in the length of the transverse wires is illustrated in greatly exaggerated form, to aid clarity of the illustration.

The slides 120, 140 have now been positioned in such a way that a wire of the maximum length with the maximum expected position error can still fit between the slides 120, 140, i.e. their distance from the predetermined centre point of the transverse wire 301 to be positioned is (L+ΔL)/2+Δx. The sprung stop 125 of the slide 120 is half the spring travel closer to the corresponding end of the transverse wire 301 than the unsprung stop of the other slide 140 to the opposite end of the transverse wire.

FIG. 5B shows a transverse wire 302 which has been inserted into the trough 103 and has not been positioned. This transverse wire 302 is slightly longer than intended (within the length tolerance) and is located to the left of the predetermined position. As soon as the transverse wire 302 has been inserted into the trough 103, the slides 120, 140 are simultaneously displaced, at the same speed, towards the ends of the transverse wire.

As illustrated in FIG. 5C, the stop of the slide 140 reaches the end of the transverse wire facing it first, after which the transverse wire 302 is displaced to the right by the slide 140. The final position of the unsprung slide 140 is given by the predetermined position of the corresponding end of a transverse wire of the correct length. The slide 120 with the sprung stop 125 compensates for the excess length of the transverse wire 302 by virtue of the spring means being compressed by more than half the spring travel (FIG. 5D). In this position, the transverse wire 302 is removed by the gripper and then fed to the welding device without its transverse position changing. The slides 120, 140, after positioning has been carried out, can be moved back outwards, before or after the transverse wire 302 is taken hold by the gripper. To ensure that the compressed spring of the resiliently mounted stop 125 does not lead to change in the position of the transverse wire 302, the slide 120 with the sprung stop 125 is retracted first, followed after a certain delay by the other slide 140.

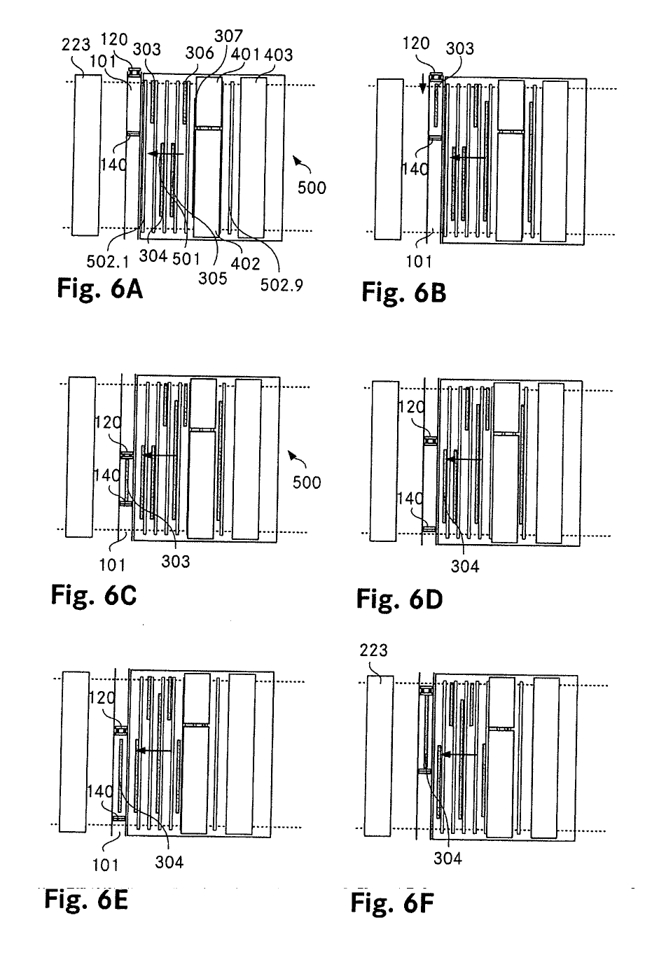

FIGS. 6A-F diagrammatically depict the method sequence involved in positioning transverse wires of different lengths. In addition to the guide 101 having the slides 120, 140 and the welding device 223 arranged parallel to and at a distance thereform, three transverse-wire magazines 401, 402, 403 for providing transverse wires of different lengths and one feed device 500 mounted ahead of the guide 101 are diagrammatically depicted. The feed device 500 is formed by a conveyor belt with ribs 502.1 . . . 502.9 arranged transversely with respect to the direction of transport 501. The transverse-wire magazines 401, 402, 403 are arranged above the feed device 500, the two transverse-wire magazines 401, 402 for short transverse-wire lengths being arranged next to one another transversely with respect to the direction of transport. The third transverse-wire magazine 403 for long transverse wires is located behind the other magazines 401, 402.

In the situation illustrated in FIG. 6A, various transverse wires 303, 304, 305, 306, 307 from the transverse-wire magazines 401, 402, 403 have already been placed in the feed device 500. These wires are, in this order, a short transverse wire 303, two medium transverse wires 304, 305, another short wire 306 and a long transverse wire 307. The transverse position of the transverse wires 303 . . . 307 in the feed device 500 corresponds to the transverse position of the corresponding transverse-wire magazines 401, 402, 403 with respect to the feed device 500. Before in each case the front transverse wire, in FIG. 6A the transverse wire 303, is placed in the guide 101, the slides 120, 140 are moved into corresponding starting positions (cf. above).

After the transverse wire 303 has been placed in the guide 101 (cf. FIG. 6B), the slides 120, 140 are moved in such a way that the transverse wire 303 in the guide 101 is transported into the predetermined release position; the feed device 500 continues to run (cf. FIG. 6C). As soon as the transverse wire 303 has been removed from the guide 101 by the transport device (not shown), the slides 120, 140 are moved into a starting position adapted to the length and position of the next transverse wire 304 (FIG. 6D).

After the next transverse wire 304 has been placed into the guide 101 (cf. FIG. 6E), the slides 120, 140 are once again moved in such a way that this transverse wire 304 is likewise transported into its predetermined release position (cf. FIG. 6F), from which it can be removed from the transport device and fed to the welding device 223.

The configuration illustrated in FIGS. 6A-F is only intended to illustrate an example. The number and arrangement of the magazines can be adapted to the geometry of the mesh to be produced and the design of the feed device. It is also possible for a plurality of magazines to be arranged above one another; because the slides can pick up and position a transverse wire which has been introduced in any arbitrary way into the guide, the demands imposed on the accuracy of the insertion position are not particularly high.

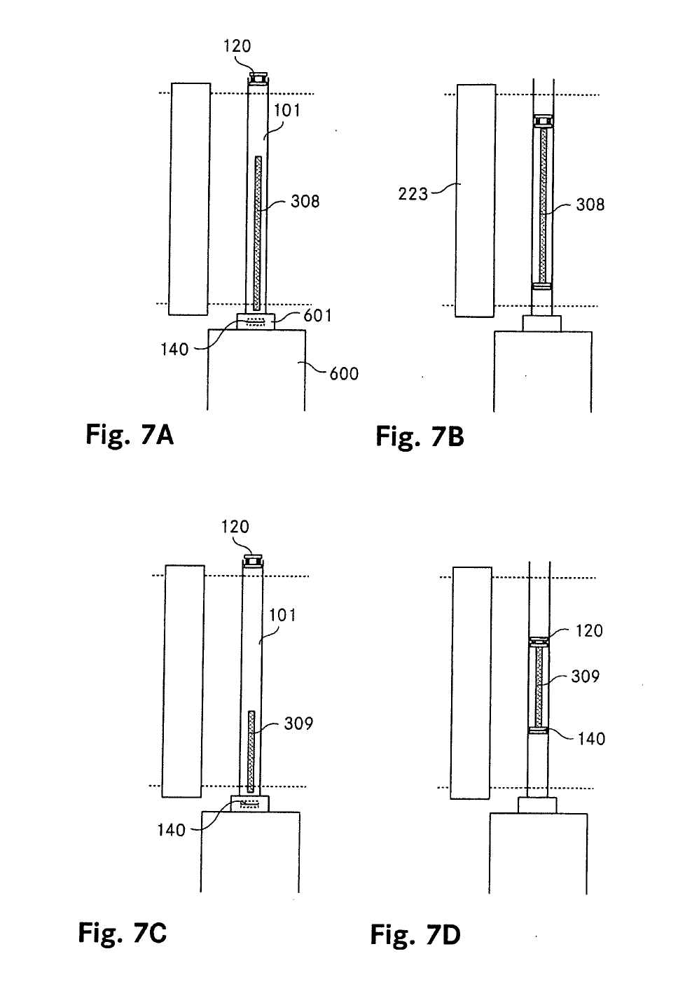

FIGS. 7A-D diagrammatically depict the method sequence involved in positioning transverse wires which have been placed into the guide direct from a system for producing transverse wires. The system 600 for producing transverse wires from a wire stock is arranged laterally next to the guide 101, the cutting apparatus 601 of the system 600 for cutting off the transverse wires being positioned in such a way that transverse wires which have been cut off can be placed into the guide 101 direct from the system 600. After they have been cut off, the transverse wires are, for example, first of all shot into an ejector passage of the system 600, which is arranged vertically above the guide 101 and parallel to the guide 101. After a flap in the base of the ejector passage has been opened, the transverse wire located therein drops directly into the guide 101.

In this exemplary embodiment, before the transverse wires are cut off, as illustrated in FIG. 7A, the slides 120, 140 are first of all, irrespective of the length of the transverse wires to be cut off, moved into starting positions close to the two ends of the guides 101. The cut-off transverse wire 308, after it has been cut off, drops out of the ejector passage into the guide 101 between the slides 120, 140. It can therefore be picked up at its end sides and moved into a predetermined release position (FIG. 7B). From this release position, it is in turn removed by the transport device (not shown) and fed to the welding device 223.

Then, the slides 120, 140 are moved back into their starting position at the ends of the guide 101 (FIG. 7C), so that the next transverse wire 309 can be cut off. This too, after it has been cut off, drops out of the ejector passage directly into the guide 101 and is then moved to the predetermined release position by the slides 120, 140. If the positioning operation is to be accelerated, it is also possible, in the context of the embodiment illustrated here, for the first slide 120, arranged on the opposite side from the cutting apparatus 600, to be moved outwards only sufficiently far for it to be possible for the transverse wire which is in each case to be cut off to be placed between the slides 120, 140.

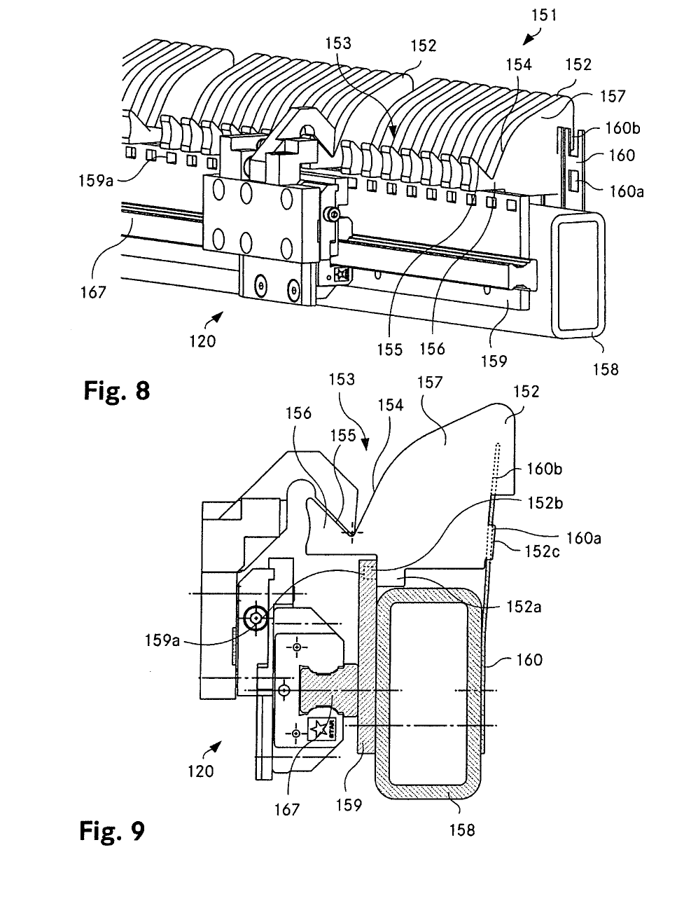

FIG. 8 shows a perspective view of a second embodiment of a positioning device according to the invention having a guide with a plurality of optionally removable sections. FIG. 9 shows a vertical cross section through this second embodiment, parallel to the longitudinal axis of the mesh-welding machine.

The guide 151 comprises a row of optionally removable trough elements 152, which together form a trough 153 which extends in the transverse direction and in which a transverse wire can be received. The trough elements 152 comprise a trough part 156, in which the trough 153 is formed, and a guide part 157, which is directed obliquely downwards towards the trough 153 and on which transverse rods delivered by a feed unit mounted upstream can slide in the direction of the trough 153. Once again, the trough is v-shaped in cross section, i.e. is formed by two walls 154, 155 which run towards one another. These walls include an angle of just under 90°.

A holding plate 159, which extends along a profiled-section support 158 and therefore along the guide 151, is bolted to the front side of the profiled-section support 158. Along its upper edge projecting above the profiled-section support 158, the holding plate 159 have a plurality of openings 159a. A series of spring elements 160 are secured to the rear side of the profiled-section support 158. These spring elements 160, in a section which likewise projects above the profiled-section support 158, have a continuous opening 160a and, at their upper, free end, a cutout 160b.

At their underside, the individual trough elements 152 have a lug 152a, on the front side of which a projection 152b is formed (cf. FIG. 9). A further projection 152c is formed on the rear side of the trough elements 152. The trough elements 152 can now be held between the holding plate 159 and in each case one of the spring elements 160. The forwarded directed projection 152b on the lug 152a on the underside of the trough element 152 engages in one of the openings 159a in the holding plate, while the projection 152c on the rear side of the trough element 152 engages in the continuous opening 160a in the corresponding spring element 160. Moreover, a projection 152d of the trough element 152 is held in the cutout 160b at the free end of the spring element 160. The trough element 152 is held securely on the profiled-section support 158 by the three contact regions.

To fit a trough element 152 to the profiled-section support 158, it is pushed from above between the holding plate 159 and one of the spring elements 160, with the spring element 160 being pressed backwards, in such a way that its spring force is overcome. Finally, the projections 152b, 152c of the trough element 158 are latched into the openings 159a, 160a in the holding plate 159 and the spring element 160, respectively. Consequently, it is held on the profiled-section support 158 by the spring force of the spring element 160. To remove a trough element 152, it is pressed backwards, in such a way as to overcome the spring force, until the projection 152b on the lug 152a on the underside of the trough element 152 comes clear of the opening 159a in the holding plate 159. Then, the trough element 152 can be moved upwards and forwards and finally removed.

A rail 167 running parallel to the profiled-section support 158 and therefore to the guide 151 is secured to the holding plate 159. The slides 120, which can move along the rail 167, correspond to those illustrated above in connection with the first embodiment. There are also no changes to the transport device. The trough elements 152 are arranged on the profiled-section support 158 in such a manner that in each case one trough element 152 is left out at the positions of the grippers of the transport device, i.e. one of the spaces made available by the holding plate 159 and the spring elements 160 remains empty.

If the positions of the grippers need to be changed, for example because transverse wires have a different length range are to be processed, the gaps are occupied by trough elements 152, and trough elements 152 are correspondingly removed at the new locations of the grippers. The area of use for the guide with optionally removable trough elements is not restricted to the present device according to the invention with two slides that can move freely. In principle, this guide can be used whenever an elongate object located in a guide is to be removed from the guide by means of a gripper.

The invention is not restricted to the exemplary embodiments illustrated. Details of the guide, the positioning device and the transport device can be altered in a very wide range of ways and adapted to the particularly requirements. The positioning and control of the slides (or other positioning devices) can also be carried out in other ways.

To summarize, it can be stated that the invention provides an apparatus for inserting transverse wires into a mesh-welding machine, which allows a high welding machine efficiency and is of structurally simple design.

1. Positioning device for positioning transverse wires for a mesh-welding machine, having a guide for receiving one of the transverse wires and two freely moveable slides for making contact with the transverse wire that has been received in the guide at two opposite end sides, the slides being designed in such a manner that the transverse wire, which has been placed in any arbitrary receiving position in the guide, can be moved along the guide into any desired, predetermined release position.

2. Positioning device according to claim 1, characterized in that the slides are each coupled to a servo axle.

3. Positioning device according to claim 2, characterized in that the coupling to the servo axles is effected by means of endless coupling means, in particular toothed belts.

4. Positioning device according to claim 2, characterized in that the servo axle is formed by a linear drive.

5. Positioning device according to claim 1, characterized in that one of the slides has a resiliently mounted stop for compensating for length tolerances in the transverse wires.

6. Positioning device according to claim 1, characterized in that one of the slides has a release mechanism, which is designed in such a manner that at a predetermined release force on the slide an element which makes contact with the transverse wire is released.

7. Positioning device according to claim 1, characterized in that the guide is formed as a trough.

8. Positioning device according to claim 1, characterized in that the guide is formed by a plurality of optionally removable sections.

9. Positioning device according to claim 8, characterized in that the optionally removable sections of the guide can be secured to a support by means of a clip connection.

10. Apparatus for inserting transverse wires into a mesh-welding machine, having a positioning device according to claim 1 arranged at a distance from a welding position of the mesh-welding machine, for moving one of the transverse wires into a predetermined transverse position.

11. Apparatus according to claim 10, characterized by a transport device for transporting the positioned transverse wire into a welding position of the mesh-welding machine, the transport device being designed in such a manner that the transverse position of the transverse wire is maintained during transport.

12. Apparatus according to claim 11, characterized in that the transport device comprises a moveable gripper for taking hold of, transporting and putting down the transverse wire.

13. Apparatus according to claim 12, characterized in that the gripper for taking hold of the transverse wire engages in a space between two spaced-apart sections of the guide.

14. Mesh-welding machine, comprising an apparatus according to claim 10.

15. Mesh-welding machine according to claim 14, characterized by a system for producing the transverse wires from a wire stock which is arranged ahead of the apparatus for inserting the transverse wires.

16. Mesh-welding machine according to claim 15, characterized in that the system for producing the transverse wires is arranged in such a manner that transverse wires which have been cut to size are placed directly into the guide for positioning.

17. Mesh-welding machine according to claim 14, characterized by at least two devices for providing transverse wires, which are arranged ahead of the apparatus for inserting the transverse wires, a transverse position of a first one of the devices being different from a transverse position of a second one of the devices.

18. Mesh-welding machine according to claim 14, having a control apparatus, which is designed in such a manner that it can move two slides for positioning the transverse wire, which are moveable with respect to the guide, independently of one another by means of servo drives, both slides being moved into lateral starting positions prior to introduction of the transverse wire into the guide, so that a distance between the slides corresponds to a length of the transverse wire that is to be introduced plus a maximum expected position tolerance (Δx) of the transverse wire.

19. Method for inserting transverse wires into a mesh-welding machine, in which, to position one of the transverse wires in the transverse direction, the following steps are carried out:
a) introduction of one of the transverse wires into a guide, with the transverse wire adopting any arbitrary receiving position; and
b) moving the transverse wire located in the guide into a predetermined release position by displacing two slides that are freely moveable with respect to the guide, a first one of the slides making contact with a first end side of the transverse wire, and a second one of the slides making contact with a second end side, opposite from the first end side, of the transverse wire.

20. Method according to claim 19, characterized in that prior to the introduction of the transverse wire into the guide, both slides are moved into lateral starting positions, with a distance between the slides in the starting positions corresponding to a length of the transverse wire that is to be introduced plus a maximum expected position tolerance (Δx) of the transverse wire.

21. Method according to claim 19, characterized in that different transverse positions are predetermined for successive transverse wires depending on a shape of a mesh that is to be produced and a length of the transverse wires.

22. Method according to claim 19, in which the transverse wires are produced in a system for producing transverse wires from a wire stock and are placed directly into the guide for positioning, without any movement of a cutting apparatus of the system in the transverse direction taking place even in the event of different predetermined release positions and/or different lengths of successive transverse wires.

23. Method according to claim 19, in which the transverse wire which has been positioned in the guide is moved into a welding position of the mesh-welding machine in such a manner that a transverse position of the transverse wire is maintained during the transport.
